(19) United States
(12) Patent Application Publication
(10) Pub. No.: US 2023/0369676 A1
(43) Pub. Date: Nov. 16, 2023

(54) HOUSING COMPOSITE OF A BATTERY AND A BATTERY HAVING THE LATTER

(71) Applicant: Robert Bosch GmbH, Stuttgart (DE)

(72) Inventor: Markus Schmitt, Tamm (DE)

(21) Appl. No.: 18/316,659

(22) Filed: May 12, 2023

(30) Foreign Application Priority Data
May 13, 2022 (DE) 10 2022 204 725.7

(51) Int. Cl. H01M 10/6556; H01M 10/42; H01M 10/667; H01M 50/204

(52) U.S. Cl. CPC H01M 10/6556; H01M 10/425; H01M 10/667; H01M 50/204

(57) ABSTRACT

A housing composite of a battery having a housing element configured to be connected to another housing element to form an interior for receiving battery cells. A cover element is connected to the housing element defining a flow space through which temperature-control fluid can flow. The housing element forms a first temperature-control structure having a plurality of first flow interference elements, and/or the cover element forms a second temperature-control structure having a plurality of second flow interference elements. The plurality of first flow interference elements and the plurality of second flow interference elements are arranged in a plurality of rows. An element of a battery controller is arranged in a thermally conductive manner on the housing element and/or on the cover element. First longitudinal directions of first rows and second longitudinal directions of second rows are arranged at an angle to one another having a value between 45° and 135°.

### BACKGROUND

The invention is based on a housing composite of a battery. The subject-matter of the present invention is also a battery with such a housing composite.

A battery module comprises a plurality of individual battery cells, each comprising a positive voltage tap and a negative voltage tap, in which case the respective voltage taps are electroconductively connected to one another and thereby able to be connected to the battery module in an electroconductive serial and/or parallel connection of the plurality of battery cells. In particular, the battery cells can each comprise a first voltage tap, in particular a positive voltage tap, and a second voltage tap, in particular a negative voltage tap, which taps are electroconductively connected to one another by means of cell connectors so that an electroconductive serial and/or parallel circuitry is formed. Battery modules are themselves in turn interconnected into batteries or entire battery systems.

Due to chemical conversion processes, the interiors of lithium-ion battery cells or lithium polymer battery cells heat up, primarily during rapid energy delivery or absorption in battery systems. The more powerful the battery system is, the greater its heating, thus resulting in the need for an efficient active thermal management system.

The prior art is, for example, the publication DE 10 2018 220 937 as well as the unpublished publication DE 10 2021 200 040, each of which describes a housing composite of a battery, which serves to temperature-control a plurality of battery cells.

Furthermore, the publication DE 10 2019 214 199 is also part of the prior art, which discloses a battery having two cooling planes. In particular, the two cooling planes are fluidly connected by means of a connecting piece, so that a common temperature-control is allowed. A supply of the temperature-control is possible, for example, via connection nozzles to a vehicle interface and thus to the cooling circuit of the vehicle.

Furthermore, the publication DE 10 2021 201 922 describes a cooling structure configured so as to be optimized with regard to a pressure drop and a heat-transmitting surface. In particular, such a cooling structure is formed on an aluminum die-cast housing of a battery module.

### SUMMARY

A housing composite of a battery having the features of the disclosure provides the advantage that an optimized temperature-control of an element can be provided to a battery controller. In particular, an optimized heat-transmitting surface can be provided with a simultaneously minimized pressure drop. Furthermore, an optimized flow surface can be provided over an entire length of a flow space. In particular, the temperature-control can thus be optimized with regard to the pressure drop of the coolant, the heat transmission, and the ventability of a flow space.

According to the present invention, a housing composite for a battery is provided for this purpose. The housing composite comprises a housing element, which is configured so as to be connected to a further housing element while forming a mutually jointly formed interior. A plurality of battery cells can be received in this interior.

Furthermore, a cover element is connected to the housing element in such a manner that a flow space through which temperature-control fluid can flow is fluid-tightly delimited. In so doing, the housing element forms a first temperature-control structure comprising a plurality of first flow interference elements, and/or the cover element forms a second temperature-control structure comprising a plurality of second flow interference elements. The plurality of first flow interference elements and/or the plurality of second flow interference elements are arranged respectively within the flow space and additionally for temperature-control fluid to flow around them. Furthermore, the plurality of first flow interference elements and/or the plurality of second flow interference elements are arranged in a plurality of rows. Adjacent rows are arranged spaced apart from one another. Furthermore, an element of a battery controller is arranged in a thermally conductive manner on the housing element and/or on the cover element.

First longitudinal directions first rows of a first region and second longitudinal directions second rows of a second region are arranged at an angle to one another, wherein the angle has a value between 45° and 135°. Preferably, the angle can also have a value of between 60° and 120°, for example between 80° and 100°.

At this point, it should be noted that flow interference elements are in principle configured so as to both increase a heat-transmitting surface region and also increase or improve a heat transmission. Flow interference elements are in particular used in order to disrupt a flow of a flowing temperature-control fluid and thereby increase a turbulence of this flowing temperature-control fluid and thus in particular to allow a transition of a laminar flow into a turbulent flow, whereby the heat transmission can be significantly increased.

It is expedient when adjacent first flow interference elements and/or adjacent second flow interference elements of first rows each have the same spacing and/or when adjacent first flow interference elements and/or adjacent second flow interference elements of second rows each have the same spacing.

Furthermore, it is also expedient when first rows and/or second rows are each configured so as to be straight. In other words, all of the respective flow interference elements of a row are arranged on a straight line.

It is also particularly expedient when adjacent first rows and/or adjacent second rows are respectively arranged offset from one another. By a displaced arrangement of the first rows to one another and the second rows to one another, a flow of the temperature-control fluid through the flow space between the individual rows can be reliably disrupted, thereby increasing the heat transmission. In particular, it is possible to disrupt the flow, adapted to the formation of the flow space both in the direction of the length of the flow space and in the direction of the width of the flow space.

It is particularly advantageous when the angle has a value of 90°. In particular, an optimized deflection of the flow within the flow space can be formed as a result.

According to one aspect of the invention, the first flow interference elements and/or the second flow interference elements of the first region, as well as the first flow interference elements and/or the second flow interference elements of the second region, are configured differently from one another. As a result, it is possible to provide an optimized heat transmission through the formation of the respective flow interference elements.

Of course, it is also possible for the first flow interference elements and/or the second flow interference elements of the first region as well as the first flow interference elements and/or the second flow interference elements of the second region to be identically configured. Thus, it is possible to form comparable flow conditions in the first region and in the second region, thereby providing an optimized pressure drop and an optimized heat transmission over the entire flow space.

It should also be noted at this point that respective flow interference elements of a first region arranged on edges are arranged by a first edge spacing to a flow limit and that respective flow interference elements of a second region arranged on edges are arranged by a second edge spacing to a flow limit. Preferably, the first edge spacing and the second edge spacing are identically formed so that comparable flow conditions are formed in the first region and in the second region.

Of course, it is also possible that the first edge spacing and the second edge spacing are designed differently, so that the temperature-control can be adjusted.

It is expedient when the element of a battery controller is arranged directly adjacent to the first temperature-control structure and/or the second temperature-control structure. This can result in a particularly reliable and optimized heat transmission.

In particular, the element of a battery controller is arranged on a side of the housing element facing away from the cover element, or the element of a battery controller is arranged on a side of the cover element facing the interior, or the element of a battery controller is arranged on a side of the cover element facing away from the housing element. In other words, this means that, for example, a temperature-control plane is formed on a top side of the housing element and on a bottom side of the cover element. The element of a battery controller can be arranged on this upper side and/or on this lower side, for example.

In addition, for an improved thermal connection of the element of a battery controller to the housing element or to the cover element, a thermal balancing material can be preferably arranged, which is in particular arranged between the element of a battery controller and the housing element and/or between the element of a battery controller and the cover element. Preferably, such a thermal balancing material can be a so-called gap pad, a so-called gap filler, or a thermally conductively formed adhesive.

It is expedient when the element of a battery controller is an electric voltage converter, in particular a DC-DC voltage converter, and/or when the element of a battery controller is an overcurrent protection device.

A DC-to-DC converter is used in order to convert a DC-DC voltage supplied to an input into a regulated or unregulated DC voltage, the voltage level of which at an output can be higher, lower, inverted, or insulated to the supplied DC voltage.

An overcurrent protection device is also known as a DC breaker and serves to interrupt an electrical circuit when the electrical current therein exceeds a fixed current strength, in particular over a specified time. Such overcurrent protection devices can, for example, be configured as a fuse or as a miniature circuit breaker.

In particular, both the DC-DC voltage converter and the overcurrent protection device can each be arranged on a separate printed circuit board. It should be noted at this point that a printed circuit board (PCB) is generally a carrier element of electronic elements, which is in particular used for mechanical fastening and electrical connection between one another. Electronic elements serve to regulate and monitor the electrical current. For this purpose, printed circuit boards comprise an electrically insulating material on which or in which further electrically conductive connections, so-called conductor tracks, which are preferably formed from copper, are arranged. In particular, the electronic elements are connected to the printed circuit board in a material-locking manner, for example particularly preferably soldered, so that an electrically conductive connection is also formed with the conductor tracks.

Furthermore, these electronic components, for example the DC-DC voltage converter or the overcurrent protection device, can each comprise a plurality of individual switching devices. Here, a switching device is basically used in order to switch a circuit so that the latter is either open or closed. These switching devices can be designed, for example, as a semiconductor switch, which is also referred to as a transistor, a power metal oxide semiconductor field-effect transistor (abbreviated as MOSFET), or an insulated gate bipolar transistor (abbreviated as IGBT). In addition, the switching device can in this case also be designed as a relay, for example, which is in principle a switch operated by an electrical current generally having two switch positions, and in which an electrical contact can be opened and closed, e.g., by an electromagnetic force. In particular, such switching devices are arranged in groups and at different positions. At this point, it should be noted that the element of a battery controller can comprise a plurality of individual switching devices.

Such switching devices heat up in particular during operation of the battery and must therefore be deheated. A plurality of regions are thus configured which are exposed to different heating systems and thus have different deheating specifications.

It should be noted at this point that, for example, a DC-DC voltage converter and an overcurrent protection device also have different specifications for heating. Overall, by means of an embodiment according to the invention, a housing composite of the battery can be provided with a deheating which can optimally satisfy the different specifications shown above.

In particular, the first flow interference elements and the second flow interference elements each have a circular cross-sectional region.

Preferably, the housing element is designed as a die-cast housing. The cover element is in particular also configured as a die-cast component. In particular, the first flow interference elements and the second flow interference elements can be formed during the respective die-casting process.

It is also expedient when the housing composite further comprises an inlet configured for an inflow of temperature-control fluid into the flow space and an outlet configured for an outflow of temperature-control fluid out of the flow space. In particular, it is possible to enable a flow guidance that is substantially U-shaped.

Overall, an embodiment of the housing element of the battery according to the present invention offers the advantage that a pressure drop can be minimized by means of a uniform flow guidance, a heat transmission can be standardized, and a homogeneous, improved ventilation can also be provided.

The subject-matter of the present invention is also a battery comprising a housing composite as described above. The housing element is connected to a further housing element while forming an interior. A plurality of battery cells are received in the interior.

### BRIEF DESCRIPTION OF THE DRAWINGS

Exemplary embodiments of the invention are illustrated in the drawings and explained in greater detail in the subsequent description.

The Figures Show:

FIG. 1 a perspective view of an embodiment of a battery module according to the invention,

FIG. 2 a bottom view of an embodiment of a housing element of a housing composite according to the invention, and

FIG. 3 a top perspective view of an embodiment of a housing composite according to the invention.

### DETAILED DESCRIPTION

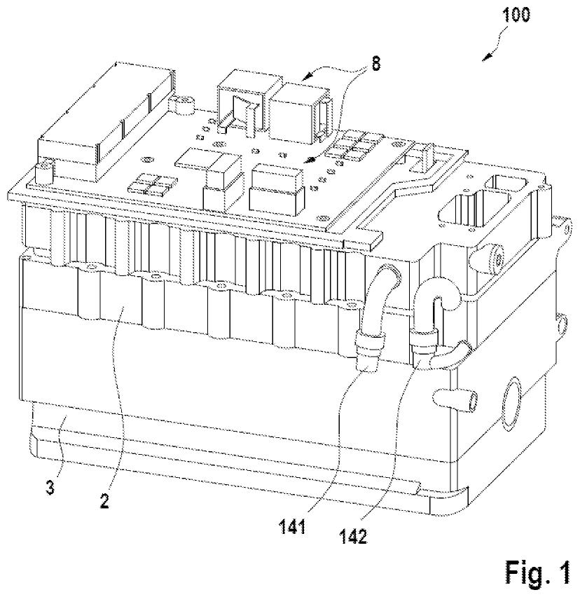

FIG. 1 shows a perspective view of an embodiment of a battery 100 according to the invention.

The battery 100 comprises a housing element 2, which is configured so as to be connected to a further housing element 3 while forming a jointly formed interior 4 for receiving a plurality of battery cells 20. In FIG. 1, it is shown that the housing element 2 and the further housing element 3 are connected to one another. The interior 4 and the plurality of battery cells 2 are not shown in FIGS. 1 to 3.

Furthermore, in FIG. 1, an inlet 141 is shown, which is configured for an inflow of temperature-control fluid 7 into a flow space 5. In addition, in FIG. 1, an outlet 142 is shown, which is configured for an outflow of temperature-control fluid 7 out of this flow space 5.

It can further be seen from FIG. 1 that an element 8 of a battery controller is arranged in a thermally conductive manner on the housing element 2.

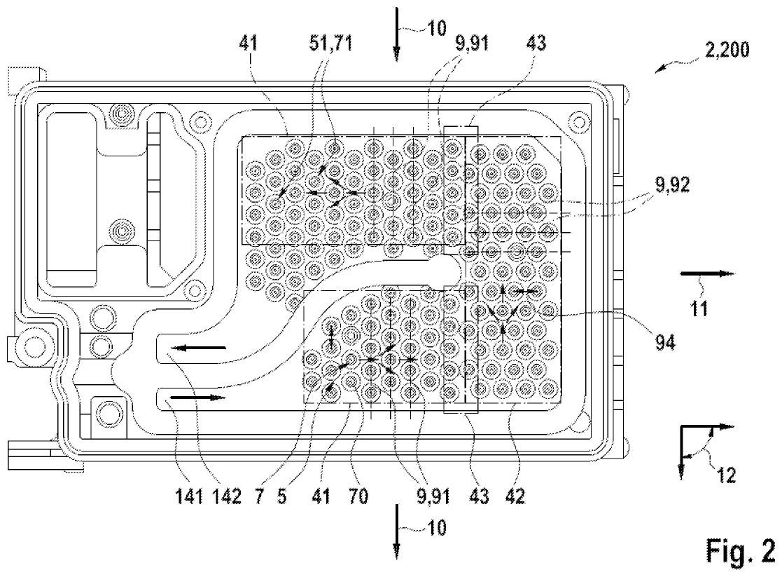

FIG. 2 shows an embodiment of a housing element 2 of a housing composite 1 according to the invention in a bottom view.

The housing element 2 is designed in particular as a die-cast housing 200.

The housing element 2 can further be connected to a cover element 6 not shown in FIG. 2 in such a manner that a flow space 5 through which temperature-control fluid 7 can flow is fluid-tightly delimited.

The housing element 2 forms a first temperature-control structure 51, which comprises a plurality of first flow interference elements 71.

Furthermore, it is also possible for the cover element 6 to form a second temperature-control structure 52, which comprises a plurality of second flow interference elements 72. This is not shown in FIGS. 1 to 3.

The plurality of first flow interference elements 71 or the plurality of second flow interference elements 72 are furthermore arranged respectively within the flow space 5 and additionally arranged for temperature-control fluid 7 to flow around them.

The plurality of first flow interference elements 71 is arranged in a plurality of rows 9. Here, adjacent rows 9 are arranged spaced apart from one another.

Furthermore, the housing composite 1 according to FIG. 2 comprises two first regions 41 as well as a second region 42. The two first regions 41 comprise first rows 91 and the second region 42 comprises second rows 92. The first rows 91 each have a first longitudinal direction 10, and the second rows 92 each have a second longitudinal direction 11. The first longitudinal direction 10 and the second longitudinal direction 11 are arranged at an angle 12 to one another. According to the exemplary embodiment shown in FIG. 2, the angle 12 has a value of 90°.

Adjacent first flow interference elements 71 of first rows 91 each have the same spacing 93, and adjacent first flow interference elements 71 of second rows 92 each have the same spacing 94. In particular, according to the exemplary embodiment of FIG. 2, the spacing 93 of the first rows 41 and the spacing 94 of the second rows 42 are identical.

Furthermore, it can also be seen from FIG. 1 that first rows 91 and second rows 92 are respectively configured so as to be straight.

Adjacent first rows 91 and adjacent second rows 92 are respectively arranged offset from one another.

According to the exemplary embodiment shown in FIG. 2, the first flow interference elements 71 of the first region 41 and the first flow interference elements 71 of the second region 42 are identical. It should be noted at this point that these can of course also be configured differently.

Two transition regions 43 are further formed between the first regions 41 and the second region 42. For example, these two transition regions 43 have a lower density of first flow interference elements 71 and second flow interference elements 72, respectively. As a result, a better deflection of the flow of the temperature-control fluid 7 between a first region 41 and a second region 42 can be achieved.

In addition, the inlet 141 as well as the outlet 142 can be seen.

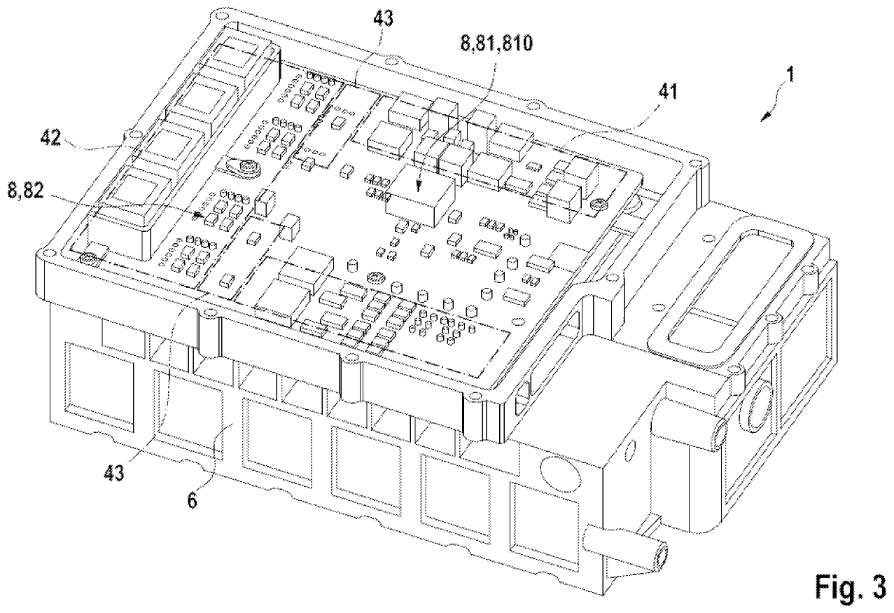

FIG. 3 shows an embodiment of a housing composite 1 in a top perspective view.

It can first be seen in particular that the element 8 of a battery controller is arranged directly adjacent to the first temperature-control structure 51.

The element 8 of a battery controller is, for example, an electric voltage converter 81, in particular a DC-DC voltage converter 810, or an overcurrent protection device 82.

Furthermore, the two first regions 41 and the second region 42 as well as the two transition regions 43 can also be seen. It can further be seen that no components requiring intensive temperature-control are positioned within the transition region 43.

The position of the cover element 6 is indicated here.

1. A housing composite of a battery (100) having a housing element (2), which is configured to be connected to a further housing element (3) while forming a jointly formed interior (4) for receiving a plurality of battery cells (20),
wherein a cover element (6) is furthermore connected to the housing element (2) in such a manner that a flow space (5) through which temperature-control fluid (7) can flow is fluid-tightly delimited,
wherein the housing element (2) forms a first temperature-control structure (51) comprising a plurality of first flow interference elements (71), and/or the cover element (6) forms a second temperature-control structure (52) comprising a plurality of second flow interference elements (72), which are furthermore arranged respectively within the flow space (5) and around which temperature-control fluid (7) can flow, wherein the plurality of first flow interference elements (71) and the plurality of second flow interference elements (72) are arranged in a plurality of rows (9),
wherein adjacent rows (9) are arranged spaced apart from one another, and an element (8) of a battery controller is arranged in a thermally conductive manner on the housing element (2) and/or on the cover element (6)
wherein first longitudinal directions (10) of first rows (91) of a first region (41) and second longitudinal directions (11) of second rows (92) of a second region (42) are arranged at an angle (12) to one another having a value between 45° and 135°.

2. The housing composite according to claim 1, wherein adjacent first flow interference elements (71) and/or second flow interference elements (72) of first rows (91) respectively have a same spacing (93) and/or that adjacent first flow interference elements (71) and/or second flow interference elements (72) of second rows (92) respectively have a same spacing (94).

3. The housing composite according to claim 1, wherein first rows (91) and/or second rows (92) are respectively configured to be straight.

4. The housing composite according to claim 1, wherein adjacent first rows (91) and/or adjacent second rows (92) are respectively arranged offset from one another.

5. The housing composite according to claim 1, wherein the angle (12) has a value of 90°.

6. The housing composite according to claim 1, wherein the first flow interference elements (71) and/or the second flow interference elements (72) of the first region (41) and the first flow interference elements (71) and/or the second flow interference elements (72) of the second region (42) are formed differently from one another.

7. The housing composite according to claim 1, wherein the element (8) of the battery controller is arranged directly adjacent to the first temperature-control structure (51) and/or to the second temperature-control structure (52).

8. The housing composite according to claim 1, wherein the element (8) of the battery controller is an electrical voltage converter (81).

9. The housing composite according to claim 1, wherein the first flow interference elements (71) and/or the second flow interference elements (72) respectively comprise a circular cross-sectional region (70).

10. The housing composite according to claim 1, wherein the housing element (2) is configured as a die-cast housing (200).

11. The housing composite according to claim 1, wherein the housing composite (1) further comprises an inlet (141) configured for an inflow of temperature-control fluid (7) into the flow space (5), and an outlet (142) configured for an outflow of temperature-control fluid (7) out of the flow space (5).

12. A battery comprising a housing composite (1) according to claim 1, wherein the housing element (2) is connected to a further housing element (3) while forming an interior (4), and a plurality of battery cells (20) are received in the interior (4).

13. The housing composite according to claim 1, wherein the element (8) of the battery controller is arranged on a side of the housing element (2) facing away from the cover element (6) or on a side of the cover element (6) facing the interior (4).

14. The housing composite according to claim 7, wherein the element (8) of the battery controller is arranged on a side of the housing element (2) facing away from the cover element (6) or on a side of the cover element (6) facing the interior (4).

15. The housing composite according to claim 8, wherein the element (8) of the battery controller is a DC/DC converter (810), or an overcurrent protection device (82).
